(19) United States
(12) Patent Application Publication
(10) Pub. No.: US 2017/0122559 A1
(43) Pub. Date: May 4, 2017

(54) SURVIVAL TOOLS, KITS, AND RELATED METHODS

(71) Applicant: Keith Wick, Edmonton (CA)

(72) Inventor: Keith Wick, Edmonton (CA)

(21) Appl. No.: 14/931,754

(22) Filed: Nov. 3, 2015

(51) Int. Cl. F23Q 13/00; B26B 9/00; A01B 1/02; G02B 19/00; G02B 25/00; F41B 3/02; B25F 1/02; B27B 21/00

(52) U.S. Cl. CPC F23Q 13/005; B25F 1/02; B26B 9/00; B27B 21/00; G02B 19/0042; G02B 25/002; G02B 19/0014; F41B 3/02; A01B 1/022

(57) ABSTRACT

Survival tools, kits, and related methods. A survival tool has: a housing with an encircling wall, the housing defining a heat chamber, the heat chamber having a combustion zone, the housing having an air vent communicating from outside the housing to the combustion zone; a receptacle; a magnifying lens; and in which the survival tool has a first operating configuration where the receptacle is within the heat chamber and oriented so that a combustion process within the combustion zone provides heat to the receptacle, and a second operating configuration where the receptacle is within the heat chamber and the magnifying lens is mounted on a magnifying lens mounting part on the housing and oriented to direct and concentrate light rays from outside the housing to within the heat chamber to heat the receptacle. Combinations of a handle part and a plurality of unique interchangeable tool parts are also disclosed for use with a survival tool.

### TECHNICAL FIELD

This document relates to survival tools, kits, and related methods.

### BACKGROUND

Outdoor camping stoves are known that are formed of a sleeve with a plurality of air vents adjacent a base of the stove. b

### SUMMARY

Various tools and kits are disclosed to provide plural functions related to survival while in the wilderness. In some cases such tools provide features that work synergistically to permit the starting of a fire and the purification of water. In some cases each objective can be achieved by a variety of respective methods, and in a compact form.

A survival tool is disclosed comprising: a housing with an encircling wall, the housing defining a heat chamber, the heat chamber having a combustion zone, the housing having an air vent communicating from outside the housing to the combustion zone; a receptacle; a magnifying lens; and in which the survival tool has a first operating configuration where the receptacle is within the heat chamber and oriented so that a combustion process within the combustion zone provides heat to the receptacle, and a second operating configuration where the receptacle is within the heat chamber and the magnifying lens is mounted on a magnifying lens mounting part on the housing and oriented to direct and concentrate light rays from outside the housing to within the heat chamber to heat the receptacle.

A method is disclosed comprising: in a first configuration of a survival tool, heating the contents of a receptacle within a heat chamber defined by a survival tool housing, using a combustion process in a combustion zone of the heat chamber; and in a second configuration of the survival tool, heating the contents of the receptacle within the heat chamber, using a magnifying lens mounted on the housing and oriented to direct and concentrate light rays from outside the survival tool housing to within the heat chamber.

A survival tool is disclosed comprising: a housing with an encircling wall, the housing defining a heat chamber; a receptacle within the heat chamber; a magnifying lens; and a guide slot in the encircling wall for guiding the magnifying lens from outside the housing to a mounted position within the housing where the magnifying lens is oriented to direct and concentrate light rays from outside the housing to within the heat chamber.

A survival tool is disclosed comprising: a cylinder with an encircling wall, the cylinder defining a heat chamber; a cup forming a receptacle and nested within the cylinder; and a magnifying lens mounted on a magnifying lens mounting part on the cylinder and oriented to direct and concentrate light rays from outside the cylinder to within the heat chamber to heat the cup.

A survival tool is disclosed comprising: a series of hollow modules threaded end to end to one another when the survival tool is in a storage configuration, in which each of the hollow modules has an encircling wall and defines an internal storage chamber; in which a heating module of the hollow modules defines a heat chamber, the heat chamber having a combustion zone, the heating module having an air vent communicating from outside the heating module to the combustion zone; and a receptacle, in which, at least when the survival tool is in an operating configuration, the receptacle is within the heat chamber and oriented to receive heat from the combustion zone.

A survival tool is disclosed comprising: a housing defining an internal storage chamber; a handle part with a first mating part; a plurality of interchangeable tool parts each having a second mating part connectable with the first mating part; and in which the handle part and the plurality of interchangeable tool parts are located within the internal storage chamber when the survival tool is in a storage configuration.

A survival tool is disclosed comprising: a handle part; a plurality of interchangeable tool parts each having a key extended from the interchangeable tool part; a sleeve configured to encircle the key and thread to the handle part to secure a respective interchangeable tool part to the handle part; a first part associated with one of the handle part or the sleeve, the first part forming a radial stop to restrict relative rotation of the key with the first part while the sleeve is being threaded to the handle part; and a second part associated with the other of the handle part or the sleeve, the second part forming an axial stop for an axial facing surface of the key to restrict relative axial separation of the key from the handle part after the sleeve is threaded to the handle part.

A method is disclosed comprising: selecting an interchangeable tool part from a plurality of interchangeable tool parts each having a key extended from the interchangeable tool part; mounting the tool part on a sleeve by passing the key through the sleeve; threading the sleeve to the handle part into a threaded position in which the interchangeable tool part is secured to the handle part, in which during threading relative rotation is restricted between the key and one of the sleeve and the handle part, and in which in the threaded position the other of the handle part or the sleeve forms an axial stop for an axial facing surface of the key to prevent relative axial separation of the key from the handle part.

A survival tool may comprise a plurality of modules threaded together, one forming a heat chamber with air vents. A survival tool may have threaded ends for modules and a nested cup. A survival tool may have an open ended cylinder with a nested cup and a steam outlet above the cup in an operating configuration. A survival tool may have an open-ended cylinder. A survival tool may have an open-ended cylinder with a magnifying lens and a nested cup. An apparatus may be provided to heat charcoal briquettes using a magnifying glass. A survival tool may comprise a housing containing a handle part with a universal connector, and a plurality of tool parts that are interchangeable with the handle part.

An open-ended tube with an open-top internal water basin positioned partway up the tube, a Fresnel lens at an upper end of the tube, lateral vents below the water basin, and a steam outlet above the water basin. The water basin is a cup fully nested within the tube and sitting atop a stop within the tube. A removable screen within a lateral slot in the tube below the water basin. The Fresnel lens is positioned within a lateral slot in the tube. The Fresnel lens is sized to fit within either lateral slot.

In various embodiments, there may be included any one or more of the following features: The housing is formed of a cylinder. The magnifying lens mounting part is located within the encircling wall of the housing. The magnifying lens mounting part comprises a guide slot in the encircling wall for guiding the magnifying lens from outside the housing to within the housing. The magnifying lens is located on a cartridge that slides within the guide slot in the encircling wall of the housing to mount the magnifying lens. A cup that defines the receptacle. The cup rests upon a seat laterally extended from an inner surface of the encircling wall when the survival tool is in one or both of the first operating configuration and the second operating configuration. The housing has a first axial end and a second axial end, the air vent is adjacent the first axial end, the magnifying lens mounting part is between the air vent and the second end, and the cup is between the air vent and the magnifying lens mounting part. The receptacle is a water receptacle and a steam release outlet is defined between the cup and the magnifying lens mounting part. In one or both the first operating configuration and the second operating configuration, a condensation tube is connected between the steam release outlet and a distilled water receptacle outside the heat chamber. The magnifying lens is a Fresnel lens. The magnifying lens mounting part is positioned such, when the magnifying lens is mounted, a focal point defined by the magnifying lens is located on a base surface of the receptacle. A mirror connected by hinge to an axial end of the housing at least when the survival tool is in the first operating configuration. The mirror is mounted by hinge to a collar, which is connected, when the survival tool is in the first operating configuration, by threading to the axial end of the housing. The housing is one of a series of hollow modules threaded end to end to one another when the survival tool is in a storage configuration. A plurality of the hollow modules has an encircling wall and defines an internal storage chamber. The survival tool has a third operating configuration where the magnifying lens is mounted on the magnifying lens mounting part on the housing and oriented to direct and concentrate light rays from outside the housing to within the combustion chamber to ignite flammable material positioned within the combustion zone. A screen positioned within the combustion zone and supporting the flammable material, when the survival tool is in the third operating configuration. The screen is located on a module that is threaded to an axial end of the housing. The housing forms a sleeve, and the survival tool has a fourth configuration where a long-distance lens is mounted within the housing to form a telescope. The housing defines an internal storage chamber, and further comprising: a handle part; a plurality of interchangeable tool parts each connectable with the handle part; and in which the handle part and the plurality of interchangeable tool parts are located within the internal storage chamber when the survival tool is in a storage configuration. A cap for an axial end of the housing, in which the survival tool has a fifth operating configuration in which one of the interchangeable tool parts are mounted to the cap while the cap is mounted to the housing. The plurality of interchangeable tool parts comprise one or more of a knife blade, a saw blade, a slingshot, a cross-bow support, and a spade. Each of the plurality of interchangeable tool parts have a key extended from the interchangeable tool part, and in which the survival tool further comprises: a sleeve configured to encircle the key and thread to the handle part to secure a respective interchangeable tool part to the handle part; a first part associated with one of the handle part or the sleeve, the first part forming a radial stop to restrict relative rotation of the key with the first part while the sleeve is being threaded to the handle part; and a second part associated with the other of the handle part or the sleeve, the second part forming an axial stop for an axial facing surface of the key to restrict relative axial separation of the key from the handle part when the sleeve is in a threaded position relative to the handle part. The first part comprises a keyway in the handle part, and the second part comprises a member laterally extended at least partially across an internal axial bore of the sleeve, the member defining an aperture shaped to pass the key in at least one radial position of the key relative to the member. The member is a plate. In which: the key has a lobed part with an out-of-round cross-sectional shape, the lobed part being connected to the tool part via a stem; the keyway and aperture have respective cross-sectional shapes that correspond with the out-of-round cross-sectional shape; the stem and aperture are shaped to permit relative rotation between the stem and the aperture; and while the sleeve is being threaded to the handle part the stem rotates within the aperture and the lobed part is clear of the aperture. The key has a rectangular box shape. A kit containing plural of the above-described parts. Methods of using the survival tool in a variety of configurations.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIGS. 1A and 1B are perspective views that collectively form an exploded view of a survival tool kit.

FIG. 2 is a perspective view of an embodiment of a survival tool kit from FIGS. 1A and 1B in an assembled storage configuration.

FIG. 3 is a section view taken along the section line 3 from FIG. 1A.

FIG. 4 is a section view of a survival tool in a water distilling operating configuration.

FIG. 5 is a perspective view of the survival tool of FIG. 4.

FIG. 6 is an exploded perspective view of a handle part, sleeve, and knife blade.

FIG. 6A is an end view of the sleeve of FIG. 6.

FIG. 6B is a close-up partially exploded perspective view of the survival tool as laid out in FIG. 6.

FIG. 7 is an exploded perspective view of the survival tool of FIG. 6, with the knife blade mounted on the sleeve.

FIG. 8 is a perspective view of the survival tool of FIG. 6 with the sleeve and knife blade mounted on the handle part.

FIG. 8A is a section view taken along the 8A section lines from FIG. 8.

FIG. 8B is a section view taken along the 8B section lines from both FIGS. 8 and 8A.

FIG. 9 is an exploded view of a survival tool having the spade, sleeve, cap, and housing from FIGS. 1A and 1B.

FIG. 9A is a top plan view of the cap of FIG. 9 with the spade key shown in dashed lines to illustrate where the spade key sits when in the threaded position or during threading of the sleeve to the cap.

FIG. 9B is a side elevation section view of a tool part key secured to the housing via the sleeve and cap of FIG. 9.

FIG. 10 is an exploded perspective view of a survival tool comprising a saw along with the sleeve and handle part of FIG. 6.

FIG. 11 is a perspective view of a survival tool assembled with the slingshot and cross bow support from FIG. 1A.

FIG. 12 is a perspective view of a survival tool assembled with the housing and slingshot sling from FIGS. 1A and 1B.

FIGS. 13 and 14 are perspective view of different extension modules from the survival tool of FIG. 1B, with closed and open first axial ends, respectively.

FIGS. 15 and 16 are perspective views of the cross bow support shown in FIGS. 1A and 11.

FIG. 17 is a perspective view of a screen support module from the survival tool of FIG. 1B.

FIG. 18 is an exploded perspective view of the mirror and hinged cap of FIGS. 1A, 4, and 5.

FIG. 19 is a side elevation section view of a monocular operating configuration of the survival tool of FIG. 1A.

### DETAILED DESCRIPTION

Immaterial modifications may be made to the embodiments described here without departing from what is covered by the claims.

TABLE 1
List of parts shown in the drawings

10 - kit
12 - cylinder/pipe/
housing
14 - magnifying glass
16 - air inlet
18 - heat chamber
19 - flame
20 - combustion zone
21 - tinder/twigs
22 - first end of cylinder
23 - threads on first end
24 - second end of
cylinder
25 - threads on second
end
26 - cylinder wall
27 - charcoal briquette
28 - slots in cylinder wall
29 - inner wall of housing
30 - screen
32 - screen cartridge
34 - magnifying lens
cartridge
36 - pair of wall sections
38 - rear slot
40 - slot shoulder
42 - cartridge shoulder
44 - indented portion of
cartridge
46 - rear projection/lobe
47 - front lobe
48 - hand gripping
surface
50 - cup
51 - height of cup wall
52 - top lip
53 - distance from cup
support to steam release
hole
54 - cup base
55 - cup sidewall
56 - cup seat (slotted
ring)
58 - water basin
60 - mirror assembly/
cap
62 - mirror surface
64 - base collar
65 - mirror cap
66 - hinge
67 - pin threads of collar
68 - male hinge part
70 - female hinge part
72 - axle hole
74 - axle hole
76 - hand gripping
surface
78 - light rays
80 - converging light rays
82 - focal point
84 - steam release
aperture
86 - water
88 - distilled water
droplets
90 - silicone tubing
91 - hand gripping
surface on screen module
92 - cylinder axis
93 - focal axis of lens
94 - screen module
95 - top surface
96 - base ring
97 - ridges
98 - screen support
100 - columns
102 - air slots
104 - first end of screen
106 - second end of
screen
108 - radiant puck
110 - interchangeable
tool part
112 - fish blade
114 - saw blade
116 - handle
118 - nut or sleeve
119 - axial end of tool
part
120 - lock cap
121 - sleeve axis
122 - tool stem
124 - tool base
126 - thin neck or stem of
tool
128 - rectangular part
130 - top shoulder
132 - sleeve stop
133 - cylindrical part of
sleeve base
134 - internal bore in
sleeve
135 - plate in sleeve
136 - stem passage in
sleeve
138 - first end of sleeve
140 - second end of
sleeve
142 - internal slot in
handle (142′ is for the
lock cap)
143 - base end of tool
stem (143′ is for the lock
cap)
144 - threads in handle
(144′ is for the lock cap)
145 - rectangular part of
internal slot
146 - internal bore in
handle
147 - cylindrical part of
internal slot
148 - first end of handle
150 - second end of
handle
152 - quarter turn rotation
of sleeve
154 - first end of lock cap
156 - second end of lock
cap
158 - base neck on lock
cap
160 - male threads on
lock cap
161 - hand gripping
surface on lock cap
162 - serrations on fish
blade
164 - hooks on fish blade
166 - sling
167 - threads on sling
support
168 - sling support
170 - support base
172 - uprights of sling
174 - lateral parts of
uprights
176 - first ends of each
tether
178 - pair of tethers
180 - second ends of each
tether
182 - connectors
184 - projectile support
186 - dart support
188 - mounting plate
190 - cutout for centering
a dart
192 - base stem of dart
support
194 - cylindrical part of
base stem of dart support
196 - lateral wings of
base stem of dart support
198 - spade
200 - extension module
cylinder
202 - first end of
extension module
204 - second end of
extension module
206 - base neck of
extension module
208 - hand gripping
surface for extension
module
210 - female threads for
extension module
212 - male threads for
extension module
214 - cap nut
218 - first end of cap nut
220 - second end of cap
nut
222 - threads on first end
of cap nut
224 - lateral bore through
cap nut

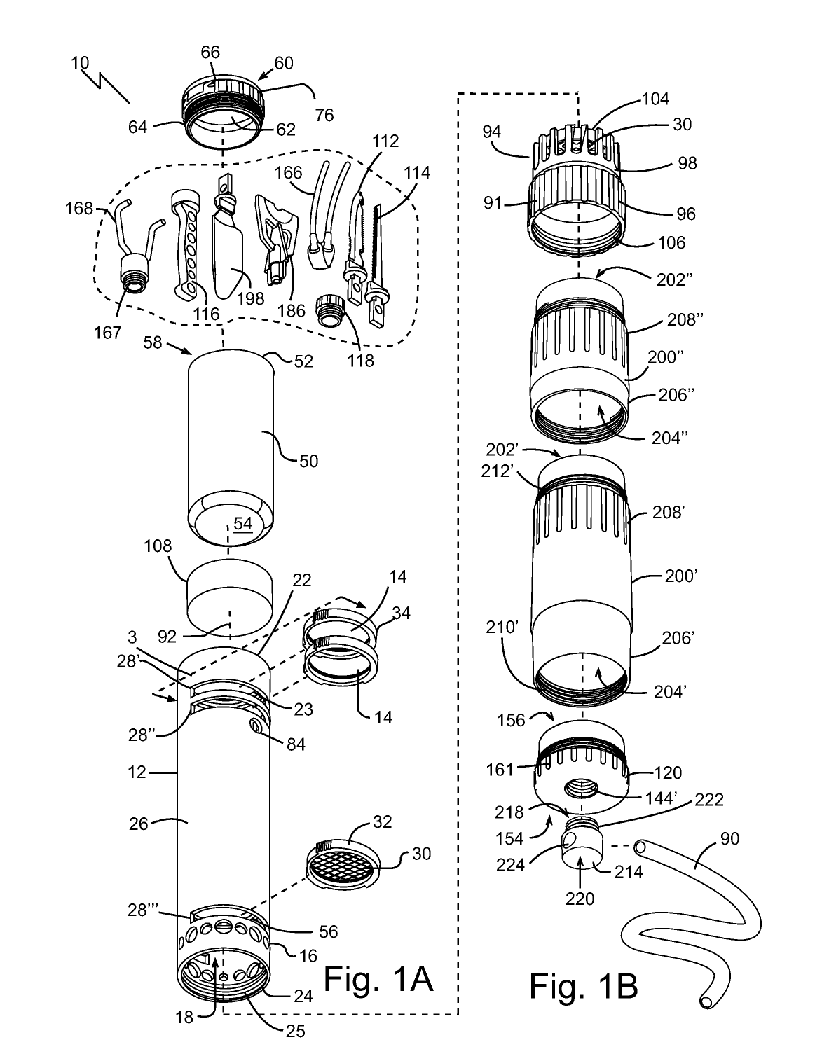

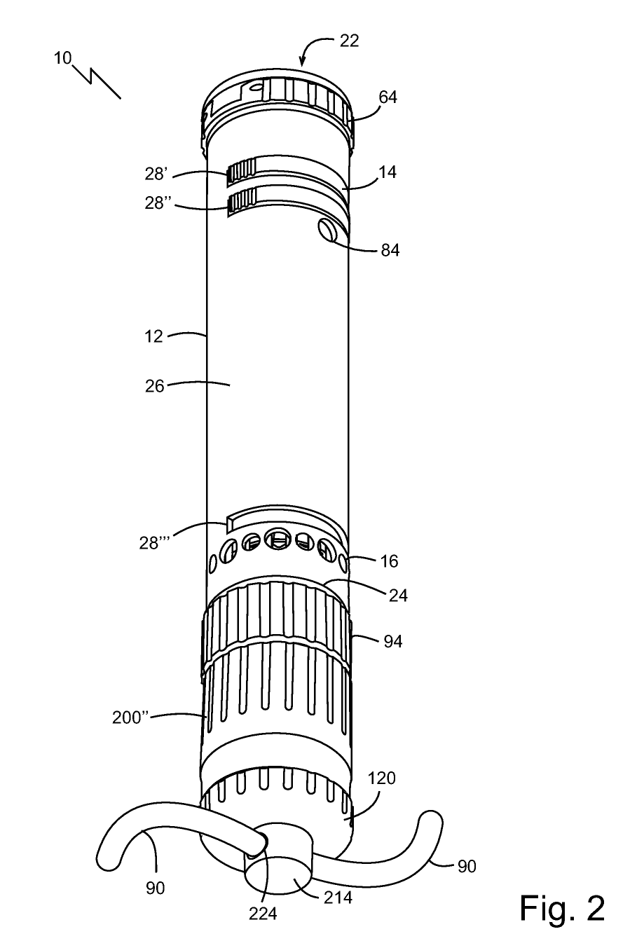

A survival tool and kit 10 may be used to provide a variety of functions to aid a user in surviving outside of civilization, for example in the bush or wilderness. Referring to FIG. 2, a survival tool and kit 10 is illustrated. Referring to FIGS. 1A and 1B, the kit 10 is exploded to illustrate the component parts. The tool 10 may have a housing, for example a cylinder or sleeve 12. The housing 12 may have an encircling wall 26 defining an internal chamber or chambers such as a heat chamber 18. As discussed further below, the housing 10 may be one of a series of hollow modules such as modules 12, 94, and 200 threaded end to end to one another when the survival tool is in a storage configuration (FIG. 2). Various cap modules such as mirror assembly 60 and lock cap 120 may be used to close the open axial ends of the assembled tool 10. Some or all of the hollow modules may also have an encircling wall and define an internal storage chamber, such as housing 12, screen module 94, and extension module or modules 200.

Housing 12 may form the primary storage and operation module as shown. The ability to thread plural modules together and cap the open ends provides a versatile tool 10 that may have modules added to or subtracted from to provide different levels of functionality and to carry additional unique or redundant tool parts 110. Referring to FIG. 4, housing 12 has a first axial end 22, which may be an open end with a suitable connector, such as threads 23, for example box threads, for connection to other modules or mirror cap 60. Housing 12 also has a second axial end 24, which may also be an open end with a suitable connector such as threads 25, for example box threads as shown, for connection to other modules or cap 120 (FIG. 2). An open end may have a connector and in an open configuration define a passageway into the interior of the housing 12.

Referring to FIGS. 1A and 4, the tool 10 may have a receptacle, such as a water receptacle, or cup 50. A cup 50 may have a base wall 54, a perimeter sidewall 55, and a top rim or lip 52. Sidewall 55 may be cylindrical in shape, corresponding to the shape of the cylindrical housing 12. A lid (not shown), for example a water tight rubber cap, may fit onto lip 52. In the example shown the receptacle is defined by a cup 50 whose base 54 rests upon a seat 56, such as a slot ring as shown welded to, or otherwise laterally extended from an inner surface 29 of the encircling wall 26. An annular shoulder may also form the seat 56. The receptacle may be permanently or integrally mounted or otherwise defined within the housing 12 in other embodiments. In some cases the cup 50 defines a water basin 58 (FIG. 4) containing water 86. The cup 50 may be nested, for example fully nested, within the housing 12, with top lip 52 positioned below a first axial end 22 of housing 12. The embodiment shown in FIG. 4 is able to heat the contents of cup 50, and in some cases distil water 86, using a variety of methods to provide flexibility to the user depending on preference, ambient conditions, and resources (such as available sun light, fuel, dry tinder, matches, flint). In some cases top lip 52 projects laterally outward from base 54 and/or cup sidewall 55 in order to contact inner housing wall 29 to form a relatively close tolerance fit to prevent or restrict convection or air/steam passage above and below the top lip 52, to improve heat transfer to the receptacle, and reduce vapor loss from the receptacle contents through air vents 16. In some cases a gasket or other seal (not shown) may be positioned around cup 50, for example on or as part of seat 54, to supplement or replace the sealing function of lip 52.

A magnifying lens 14, such as a Fresnel lens as shown, may be provided as part of tool 10. Referring to FIG. 4, in use the magnifying lens 14 may be mounted on a magnifying lens mounting part, such as guide slot 28, on the housing 12. In the operating configuration shown in FIG. 4, when mounted the lens 14 is oriented to direct and concentrate light rays 78 from outside the housing 12 to within the heat chamber 18 to heat the receptacle 50. In other embodiments the lens 14 may mount, for example by threading, for further example by mounting in collar 64 of cap mirror assembly 60, to an axial end 22 or 24 of housing 12. In the example shown the magnifying lens mounting part, or guide slot 28, is located within the encircling wall 26 of the housing 12.

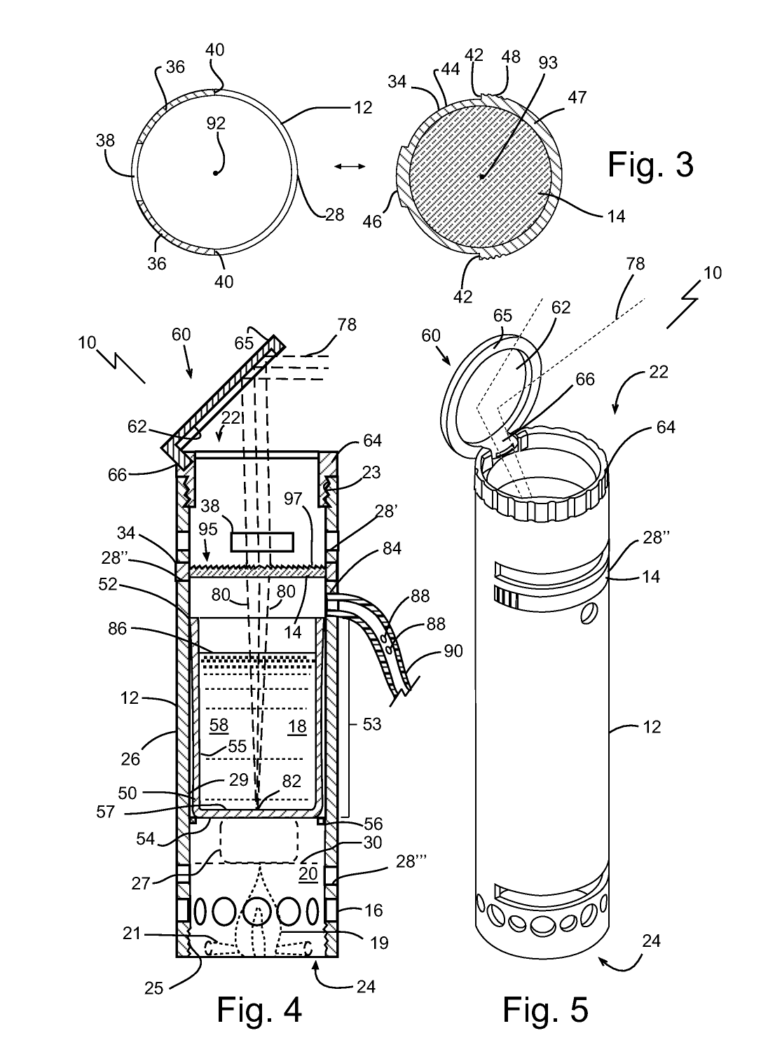

Referring to FIGS. 3 and 4, the guide slot 28 may be configured to guide the magnifying lens 14 from outside the housing 12 to within the housing 12. The magnifying lens 14 may be located on a cartridge 34 that is shaped to slide within the guide slot 28 in the encircling wall 26 of the housing 12. The guide slot 28 may be defined by a lateral entry slot in the encircling wall 26. The cartridge 34 may have a lobed appearance with one or more lobes, such as rear and front lobes 46 and 47, respectively, shaped to fit within rear and entry slots 38 and 28, respectively of the housing 12. The guide slot 28, particularly opening 28, acts as a track that aligns the cartridge 34 in the correct lateral orientation, with magnifying lens 14 perpendicular to housing axis 92 (FIG. 3), while the rear slot 38, shoulders 40, and inner surfaces of wall sections 36 act to center the lens 14 (focal axis 93) co-axially with housing axis 92 by contacting rear lobe/pin 46, shoulders 42, and indented wall portions 44, respectively to limit lateral travel through the housing 12. Although one example is shown of a mechanism that provides guiding action, other suitable mechanisms may be used. The cartridge 34 may fit with a snap fit into slot 28 to restrict accidental removal. The wall sections 36 may be configured to extend to and over a theoretical center diameter line (not shown), to provide a limited inward gripping function on wall portions 44.

Referring to FIG. 4, the lens 14 may be a Fresnel lens. Like a spherical lens, a Fresnel lens converges collimated light rays 78 (parallel rays) to a focal point 82. However, unlike a spherical lens, the Fresnel design has a thin, compact shape that allows the construction of lenses of large apertures and short focal length without the mass and volume of material that would be required by a lens of conventional design. A Fresnel lens may take the form of a relatively flat sheet as shown. A Fresnel lens may divide a surface, in this case a top surface 95, of lens 14 into a set of annular sections, shown by concentric ridges 97. The focal length of the lens 14 may be limited by the number, size, and slope of each ridge 97. In each section, the overall thickness is decreased compared to an equivalent simple lens. This effectively divides the continuous surface of a standard lens into a set of surfaces of the same curvature, with stepwise discontinuities between them. Each section or ridge 97 may carry the same curvature as a section of a spherical lens, or may have an angled flat contour, both of which may achieve the desired focusing effect. The angle and curvature of each ridge 97 changes from center to periphery, reflecting the change in same for a spherical lens. A Fresnel lens may be an array of prisms arranged in a circular fashion, with steeper prisms on the edges, and a flat or slightly convex center. A Fresnel lens may be made of suitable material such as glass or plastic.

Referring to FIG. 4, when in the operating configuration shown the lens 14 may be positioned such that a focal point 82 defined by the magnifying lens 14 is located on a base surface 57 of the inside of the receptacle 50. The base surface 57 may be configured to absorb light rays 80, for example by being darkly colored, or by positioning a light absorbing dark object on the base surface 57. The lens 14 may be designed such that the focal point 82 is achieved when cup 50 is filled to a desired level with water 86, if the refraction of converging rays 80 through water 86 is considered. In other cases the lens 14 may be positioned and structured to direct light 80 to a focal point 82 that is not within cup 50, for example, if rays 80 are directed underneath inner cylinder 50, for example underneath or to base 54. The focal point 82 may be a range of focal points. Plural slots, for example slots 28′ and 28″ may be positioned to permit the lens 14 to be positioned at different positions, depending on where the focal point 82 is desired to be located, or to permit plural lenses 14 with different focal lengths to be used in different axial positions. In some cases slots, such as slots 28′, 28″ and 28′″ may be located adjacent opposed axial ends 22 and 24 of housing 12. The use of slots 28 adjacent different ends permits the mounting of lens 14 to receive light from either end 22 or 24. Such configurations may also facilitate the use of lenses 14 with different focal lengths. For example, in one case a lens 14 is located in slot 28′″, the housing 12 is inverted such that end 24 is oriented up, cup 50 is positioned between slots 28′″ and 28′ or 28″, opening toward slot 28′″, with base 54 resting upon a cartridge 34 in slots 28″ or 28′.

Referring to FIGS. 4 and 5, one or more light redirection devices, such as a mirror 62, may be provided as part of tool 10. The mirror 62 may act to direct sunlight rays 78 from outside the housing 12 to the lens 14, where such rays are then converged into focal point 82 to generate heat. Rays 78 may originate from a suitable source, such as the sun, or from an artificial source such as a flashlight. The mirror 62 may be connected to the housing 12 such that the position and orientation of the mirror 62 is adjustable. For example the mirror 62's position may be adjustable to permit the mirror's 62 to be positioned, to maximize light to lens 14, after housing 12 is positioned to rest on a ground surface.

Referring to FIGS. 4 and 18, the mirror surface 62 may be mounted on a cap 65, which may be a disc as shown, the cap 65 being connected by hinge 66 to a collar 64 that threads, for example by pin threads 67 as shown, to threads 23 of first axial end 22 of housing 12. The hinge 66 may be provided by a male and female connection as shown, for example male part 68 depending from cap 65, connecting within female groove part 70 of collar 64. When mounted, apertures 72 and 74 in the cap 65 and collar 64 may align to permit passage of a rod (not shown), which may be sized and structured to function as an axle while providing sufficient friction to restrict rotation when no external user force is =exerted upon cap 65. The cap 65 and collar 64 may form a mirror cap assembly 60, which may define one axial end of the tool 10 when in the closed position, for example shown in FIG. 2. Mirror cap assembly 60 may be threaded to either end 22 or 24 of housing 12.

Referring to FIG. 4, the housing 12 may be arranged into one of a variety of distillation operating configurations for distilling contaminated water 86 in cup 50. A steam release aperture or outlet 84 may be defined between the cup 50, for example top rim 52, and the magnifying lens mounting part 28. Other arrangements of outlet 84 may be used, but in the example shown, water that becomes steam rises from cup 50 and passes out of housing 12 through steam release outlet 84, which may have mounted to it an outlet conduit such as silicone condensation tube 90. Tubing 90 may carry steam, which may condense to droplets 88 during travel along tubing 90, before which droplets 88 are dispensed into a suitable distilled water receptacle, such as extension module 200′ (FIG. 1B) for later use. A distance 53 from the cup support seat 56 to the steam release outlet 84 may be greater than or equal to the distance from seat 56 to top rim 52 when cup 50 is in the seated position shown.

In the example shown the lens 14 blocks axial travel of steam past the lens 14, directing steam to exit housing 12 via outlet 84. Other configurations may be used to collect distilled water, such as a distilled water receptacle nested within housing 12 above cup 50. If lens 14 is mounted within slot 28′, a cartridge 34 with no lens (not shown) or a non-magnifying lens (not shown) may be positioned within slot 28″ in order to seal off the distillation chamber of the housing 12 to direct steam into outlet 84 or another suitable desired location.

Referring to FIGS. 1A and 4, the heat chamber 18 may have a combustion or fire zone 20. An air vent, such as a series of plural lateral vents 16 may communicate from outside the housing 12 to the combustion zone 20. The combustion zone 20 may be adjacent an axial end, such as end 24, of housing 12, although in other cases either end 22 or 24 may form a combustion zone. When cup 50 rests upon seat 56 within heat chamber 18, the cup base 54 is spaced above axial end 24 in order to define combustion zone 20. In one operating configuration shown with dashed lines in FIG. 4, a combustion process, such as fire 19, within combustion zone 20 acts to transfer heat to the contents of the cup 50, which is located above and adjacent the zone 20, ultimately heating and boiling the water 86 in cup 50 leading to distillation of water 86 through tubing 90.

Air vents 16 permit the maintenance and initiation of a combustion process, such as a fire 19, within zone 20. Slot 28′″ may also act as an air vent 16 to improve breathing within zone 20. The part of encircling wall 26 that defines the combustion zone 20 and through which vents 16 pass forms a wind shroud, to permit a fire 19 to be started, for example using tinder 21 within zone 20, irrespective of windy conditions outside the housing 12. A flint (not shown) may be provided with tool 10, or otherwise used to light tinder 21 by drawing the flint through one of the vents 16, rubbing the flint against the bore wall of vent 16 to initiate a spark. One or more of air vents 16 may be adapted to work with a flint to create a spark. In other cases, end 24 may be positioned within an existing fire, in order to channel heat from the fire up to base 54 and cup 50.

In one case the air vent 16 is adjacent to one of ends 22, 24, and the magnifying lens mounting part 28 is between the air vent 16 and the other end 22, 24, for example adjacent the other end 22, 24. The cup 50 is shown located between the air vents 16 and the magnifying lens mounting part 28. Such an arrangement permits the user to select to carry out a combustion process at one end, such as end 24, or if sufficient light is available, a heating process by magnifying light rays 78 using lens 14 at or near the other end, such as end 22, in order to heat the contents of cup 50 between lens 14 and combustion zone 20. Such an arrangement provides a compact housing 12 that is able to provide heating from plural sources, providing flexibility to a user in a single tool 10.

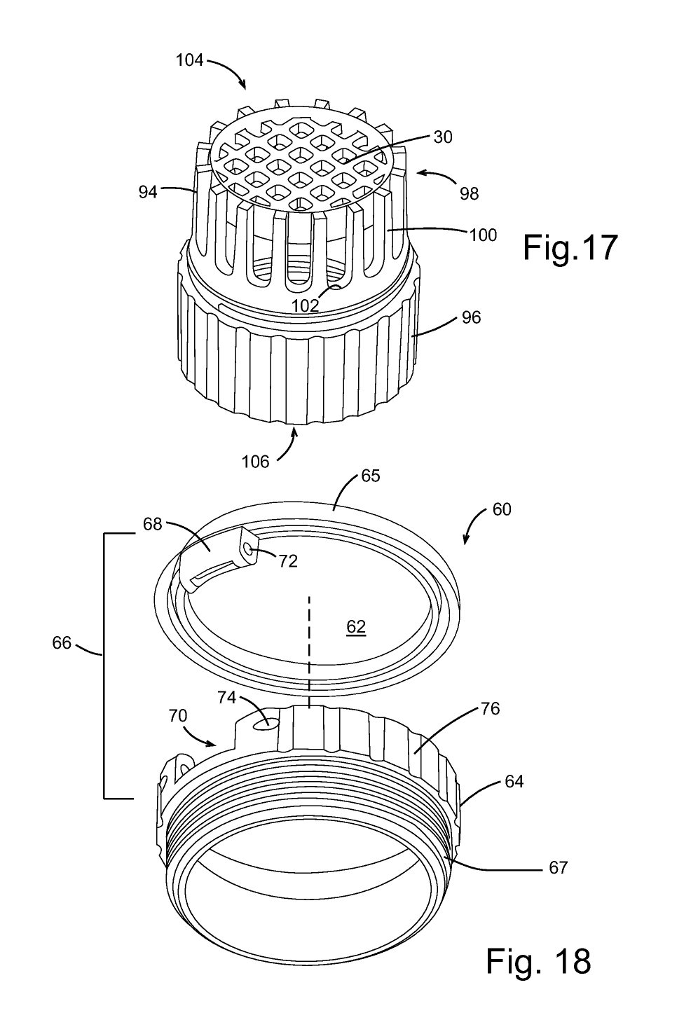

Referring to FIGS. 1B, 4 and 17, a support, such as a screen 30 may be provided in some operating configurations, to support a heat releasing object, such as a charcoal briquette 27 (FIG. 4) or radiating puck 108 (FIG. 1A). The screen 30 may be provided in a suitable fashion. Referring to FIG. 1A, in one example the screen 30 is mounted on a cartridge 32 that mounts within a screen mounting part such as guide slot 28′″, in the same or a similar fashion as lens cartridge 34 mounts to the guide slot. Referring to FIGS. 1B and 17, in another example the support or screen 30 may be located on a module 94, which may be partially or fully nested within an axial end of the housing 12, for example, if module 94 is threaded to axial end 24. The module 94 may space heat screen 30 above the end 24 of housing 12, for example into the position shown in FIG. 4.

Referring to FIGS. 1B and 17, the module 94 may have a base, such as ring 96, forming a screen support 98, which may include a series of columns 100 that support and space screen 30 above ring 96 within combustion zone. Referring to FIGS. 2 and 17, columns 100 may define slots 102, which may align with air vents 16 when module 94 is installed to axial end 24, to facilitate air flow through air vents 16, slots 102, and through screen 30 to the briquette or other combustion process supported upon screen 30. A screen 30 is understood to include a support surface, or one or a plurality of members, including an apertured plate (not shown), that are configured to support a heat releasing object and permit airflow from beneath. In other cases the screen 30 may be replaced by a plate or other surface that forms a restriction or block to airflow from end 24 to cup 50.

Referring to FIG. 4, in one operating configuration a flammable material, such as a charcoal briquette 27, is positioned on screen 30 (the position of screen 30 in such a configuration is indicated in FIG. 4 by dashed lines). There are several options in which such material may be used. In one case, the briquette may be ignited in an external fire, or a fire 19 within combustion zone 20. In another case, the briquette may be ignited using the lens 14. For example, the receptacle or cup 50 may be removed with the briquette on the screen 30, or the briquette dropped into the empty cup 50, and the lens 14 used to direct and concentrate light rays 78 to a focal point 82 on or sufficiently close to the briquette to ignite the briquette and begin the combustion process. Once ignited, the briquette 27 can be placed upon the screen 30 if not already on the screen 30, and the cup 50 can be placed upon the seat 56, the cup 50 containing water 86. Thus, a distillation process can be carried out using heat from the combustion process occurring within the briquette 27.

Once the briquette 27 is spent or has achieved its objective of distilling the contents of cup 50, the remains may be dumped out of the bottom end 24 of housing 12 by sliding the screen 30 out of slot 28′″ if a screen cartridge is used, or by unscrewing module 94 and dumping the remains at a suitable location outside the housing 12. Although briquette 27 is described as being used, any suitable flammable material or fuel may be used including coal, tinder, wood chips, peat, coal dust, combustible biomass material, sawdust, or paper, and others. In some cases the material 27 is selected to provide sufficient burn time to carry out the distillation process. In one case such material 27 is compressed to increase burn time. In another case the tool 10 provides a solar oven to cook food upon screen 30 or within cup 50. In another case the lens 14 may be used to ignite flammable material upon the screen 30, and the screen 30 pulled out (if on a cartridge 34) or unscrewed, in order to drop the ignited briquette into a fire starting bundle of tinder to start a larger fire on a ground surface (not shown). Different focal lengths of lenses 14 may be provided for such a purpose, for example a lens 14 that focuses on the base surface 57 and another lens that focuses at an intermediate axial position of the cup 50 corresponding to a theoretical level of food in the cup 50 during cooking.

Referring to FIG. 1A, heat retaining and radiating object, such as radiant puck 108 may be used to store and slowly release stored heat through radiation. Puck 108 may be heated in a fire, for example an external fire or a combustion process within zone 20, and once heated puck 108 may be placed on screen 30, to prevent direct contact between puck 108 and the ground or a user. Afterward, the housing 12 may be capped at both ends or otherwise configured to safely retain puck 108 from falling out. Puck 108 will then slowly release stored heat by radiation, providing a safe, long-lasting heat source that may be used to heat a tent or chair for example. The object or puck 108 may be made of suitable material with a relatively high heat capacity, such as a piece of aluminum that is cored out, filled with sand, and hard welded.

Thus, referring to FIG. 4, the survival tool 10 illustrated provides two or more different ways of heating, and in some cases distilling, the contents of the receptacle (cup 50). The first is by direct heating with light rays 78 concentrated using lens 14. The second is by starting or maintaining a combustion process, for example a fire 19, within combustion zone 20 in order to heat the cup 50. Many variations of the second method may be used. The combustion method may involve starting and maintaining a fire 19 by igniting tinder 21 or other suitable fuel in zone 20, for example using a flint or match while housing 12 provides a wind shroud. The combustion method may also involve using the lens 14 to ignite a flammable material or fuel source such as a charcoal briquette 27 and leaving the burning material upon a screen 30 adjacent the base 54 of cup 50. In a further example the end 24 of housing 12 may be placed in an external fire and to permit heat from coals or flames from the fire to heat the contents of cup 50.

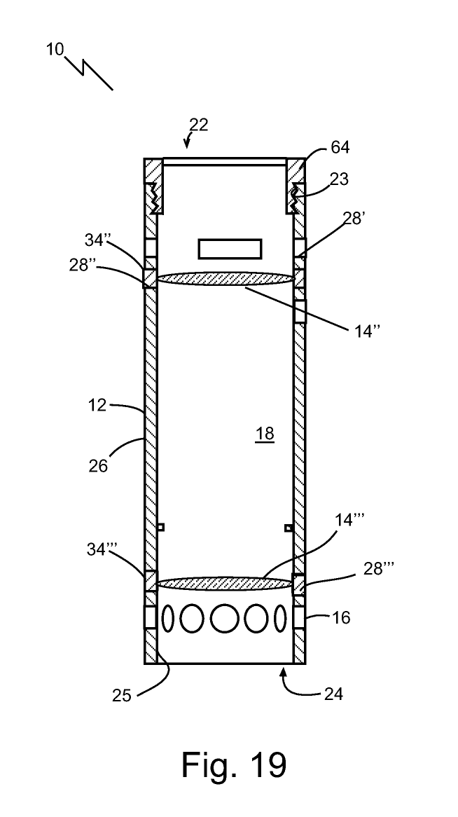

Referring to FIG. 19, a telescope or monocular operating configuration is illustrated. The housing 12 may form a sleeve, and a long-distance lens, in this case lenses 14″ and 14′″ located on respective snap ring cartridges 34″ and 34′″, mounted within the housing 12 to form a telescope. In some cases the tool 10 is provided with one or two cartridges 34, and the lenses, whether Fresnel or long-distance, may be swapped in or out as needed. Two or more lenses 14 may be used, for example a convergent and divergent lens, to aright the resulting image after magnification. For example a four times scope lens may be coupled with a convex lens to give four times optical zoom with a relatively large viewing area. In some cases a single lens 14 is used, with a focal point selected to land outside of ends 22 or 24 in the expected position of a user's eye. Plural lenses 14 may be arranged on a single cartridge 34 in some cases, for a compound effect. A prism lens (not shown) may be used. An adjustable lens cartridge 34 (not shown) may be used to adjust the focus of the monocular.

Referring to FIG. 1A, a variety of unique tool parts, such as one or more of a slingshot support 168, spade 198, crossbow dart support 186, fish or hunting blade 112, and saw blade 114 may be provided as part of tool kit 10. The tool parts may be interchangeable tool parts that are each connectable individually with a common handle part 116. The housing 12, for example the interior of the cup 50, may form an internal storage chamber when the tool 10 is in a storage configuration (FIG. 2). The tool parts and handle part 116 may be sized and shaped to fit within the internal storage chamber when the survival tool 10 is in the storage configuration. In some cases of a storage configuration the tool parts and handle part may be spread around in different internal storage chambers, such as ones defined by cup 50 and extension modules 200′ or 200″ as needed. Additional tool parts may be added or subtracted to the kit 10 as desired. The use of a common handle part 116 that connects to all such tool parts via a universal mounting system reduces the combined weight and size of material required to provide the same number of tools, as each tool part need not be supplied with its own dedicated, integral handle. Such a system also permits relatively larger tool parts to be fit into the same storage space than if each tool part had its own dedicated handle part. As well the example shown provides a simple to machine key 122 that takes up less space than if each tool part 110 had its own dedicated threads. The handle part 116 may have a common female or male part, and the tool parts 110 may have respective corresponding male or female parts, for coupling to the common part of handle 116, even if the connecting parts of tool part 110 are different from one another (compare the connecting parts of slingshot support 168 and blade 112 for example).

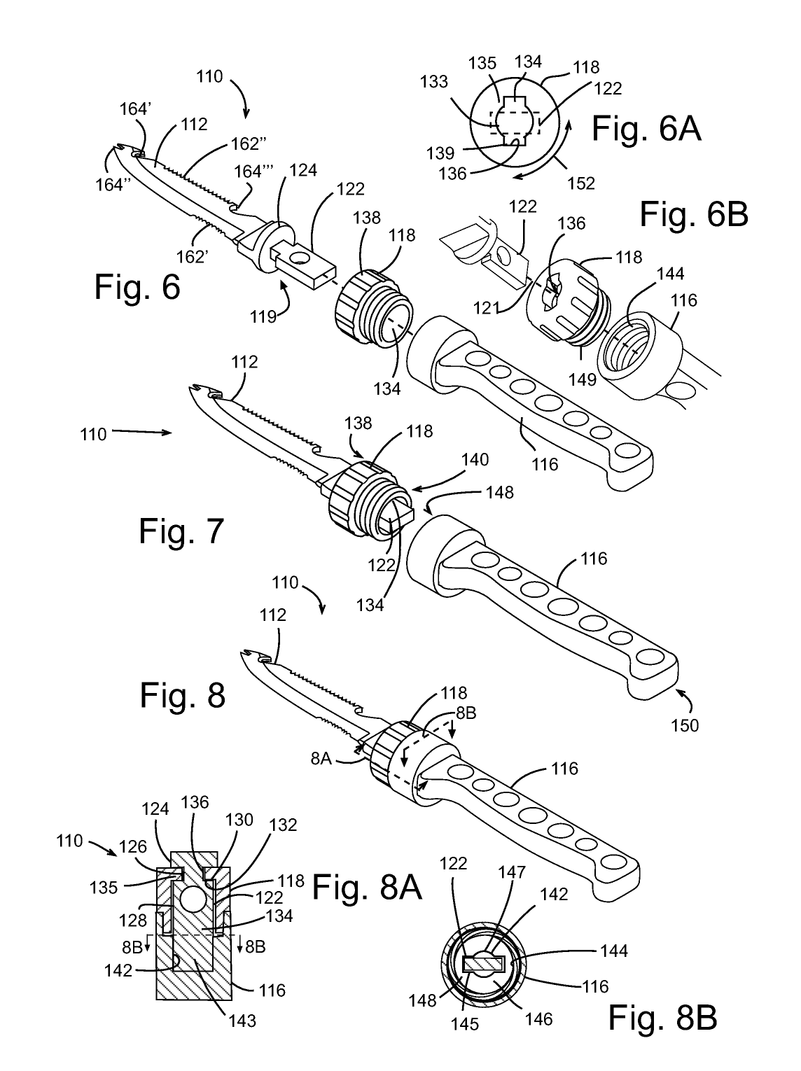

Referring to FIGS. 6-8 an embodiment of a universal connection mechanism for securing tool parts 110 to the handle part 116 is illustrated, using the example of a hunting blade 112. Blade 112 may be a standard hunting blade, with additional features such as serrated portions 162′ and 162″, and hooks 164′, 164″, and 164′″. It should be understood that the components that make up the universal connection mechanism between blade 112, sleeve 118, and handle part 116 may apply to all or plural tool parts 110 even though described only for blade 112. Each tool part 110, such as blade 112, may have a key 122 extended from the tool part 110, such as extended from a tool base plate 124 at an axial end 119 of the blade 112. The key 122 may be configured to fit and lock with a corresponding keyway 142 of the handle part 116.

A nut or sleeve 118 may be provided as part of the universal connection mechanism used to secure the tool part 110 to the handle part 116. Referring to FIGS. 7 and 6B, sleeve 118 may be configured to encircle the key 122, for example by passing key 122 through an axial aperture 136 in the sleeve 118. Sleeve 118 may interlock, for example by threading to, the handle part 116 to secure a respective interchangeable tool part 110 to the handle part 116.

A first part and a second part may be associated with the universal connection mechanism. The first part may be associated with one of the handle part or the sleeve, while the second part is associated with the other of the handle part or sleeve. Referring to FIGS. 8A and 8B, the first part may be an internal slot or keyway 142 contoured in axial end 148 of handle part 116. The first part forms a radial stop to restrict relative rotation of the key 122 with the first part while the sleeve is being threaded to the handle part 116. Referring to FIGS. 7, 8A and 8B, the key 122 may have a lobed part 143 with an out-of-round cross-sectional shape (FIG. 8B). The key 122 or the lobed part 143 may have a rectangular box shape as shown for ease of manufacturing. By providing such a structure for key 122, including other suitable structures that lack threading, the key 122 and tool part 110 may be made smaller to take up less space in tool 10, and can be made via simpler, less costly manufacturing processes than does a process that involves thread-forming on tool part 110. The lobed part 143 may be connected to the tool part 110 via a stem 126, which forms a relatively thin neck between the key 122 and a base plate or flange 124 at axial end 119 of tool part 110.

Referring to FIGS. 6A, 6B, and 8B, the keyway 142 in handle part 116 (FIG. 8B), and the aperture 136 in sleeve 118 (FIGS. 6A and 6B), may have have respective cross-sectional shapes that correspond, for example match with close tolerance, with the out-of-round cross-sectional shape of the key 122. Thus, key 122 may fit within each of aperture 136 and keyway 142 in a single or limited range of radial positions relative to the respective aperture 136 and keyway 142. Referring to FIGS. 7, 8A, and 8B, once the sleeve 118 encircles the key 122 (FIG. 7), the sleeve 118 is positioned adjacent end 148 of handle part 116, and the lobed part 143 aligns with keyway 142, the lobed part 143 of key 122 enters and engages the keyway 142. Further rotation between key 122 and handle part 116 is thus restricted or prevented during installation.

Referring to FIGS. 6A, 6B and 8A, the second part may be a member such as plate 135 laterally extended at least partially across an axis 121 and internal axial bore 134 (FIG. 6B) of the sleeve 118. The plate 135 may define aperture 136, which is shaped to pass the key 122 in at least one radial position of the key relative to the plate 135. Referring to FIG. 8A, the second part, for example plate 135, may in use form an axial stop 132 for an axial facing surface or shoulder 130 of the key 122 to restrict or prevent relative axial separation or pullout of the key 122 from the handle part 116. Axial separation may be restricted when the sleeve 118 is in a threaded position (FIG. 8A) relative to the handle part 116, in addition to during a portion or the entirety of the threading process. Referring to FIGS. 7 and 8A, once the key 122 passes aperture 136 to stem 126, the lobed part 143 is clear of the aperture 136, due to the thickness of the plate 135 in the axial direction, while the plate 124 acts as a stop to align stem 126 within aperture 136 and prevent over insertion of key 122 through aperture 136.

Referring to FIGS. 6A and 8A, the stem 126 and aperture 136 may be shaped to permit relative rotation between both components. For example, a maximum outer diameter of the stem 126 may be less than a minimum inner diameter of the aperture 136 drawn in a cross-sectional plane perpendicular to axis 121 (this is the plane of the drawing in FIG. 6A). Thus, the stem 126 forms an axle that rotates within aperture 136 during installation but not after being secured in the threaded position. Referring to FIGS. 8A and 8B, once the key 122 enters the keyway 142, and threading begins, the sleeve rotates around the stem 126 and out of the radial position required for lobed part 143 to enter and exit the aperture 136, thus forming the axial stop 132.

Referring to FIGS. 6A, 6B, and 8A, the threads 149 of sleeve 118 engage the threads 144 of handle part 116, and one or both of same may be configured to form a thread stop after a predetermined amount of rotation, for example a quarter turn 152 (FIG. 6A). At a quarter turn rotation the key 122, specifically the lobed part 143, will be axially stopped from axial removal from sleeve 118, while the sleeve 118 will be secured to the handle part. In addition, the tool part 110 remains secured to handle part 116 even after inadvertent, small reverse rotational movements to prevent accidental tool part 110 release during use. The sleeve 118 and handle part 116 may be configured to reach a threading stop at a relative radial position other than one that aligns the key 122 for axial exit from the aperture 136. In some cases the number of turns follows the formula X=n(½)+¼, where n is an integer and X represents the maximum amount of a turn required to thread the sleeve 118 and handle part 116 together. A rigid universal connection may be formed in the threaded position between tool part 110 and handle part 116, and the combination of handle part 116, sleeve 118, and tool part 110 may be used as a unitary tool to perform various functions such as gutting a fish in the case of blade 112. Referring to FIG. 10 a further example of the universal connection method is shown with a saw blade 114.

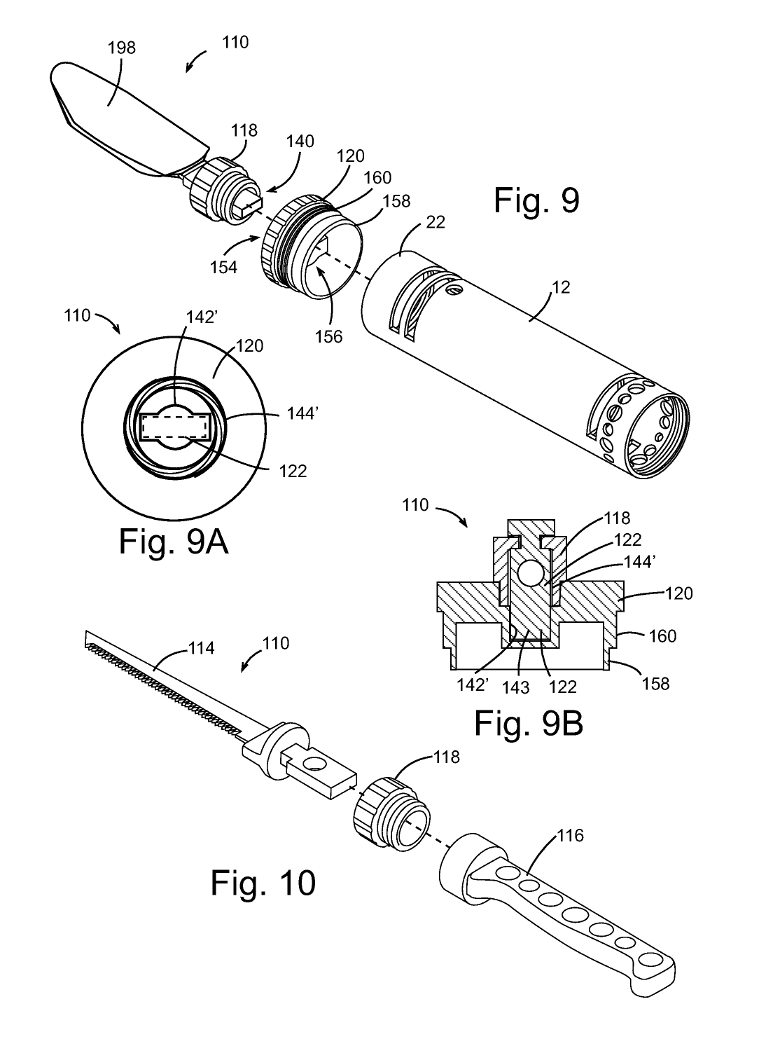

Referring to FIGS. 9, 9A, and 9B, the universal connection mechanism may involve more than just connection to handle part 116. For example, a cap 120 may be provided for interlocking, for example threading to, an axial end such as end 22 of the housing 12. The cap 120 allows the housing 12 to function as an additional handle to supplement or replace handle part 116. The outer axial end 154 of cap 120 may carry the same or similar structure as the outer axial end 148 of handle part 116, in order to permit the sleeve 118 and tool part 110 to secure to the cap 120, and hence the housing 12, in the same fashion as securing to the handle part 116. For example, cap 120 may include a keyway 142′ and threads 144′ for the key 122 and sleeve 118 respectively. By providing the ability to mount the tool part 110 to the housing 12, torque and lever advantages are achieved when using the combined tool as compared to the handle part 116, because of the relatively wider diameter of the housing 12, and the relatively longer axial length of the housing 12, respectively.

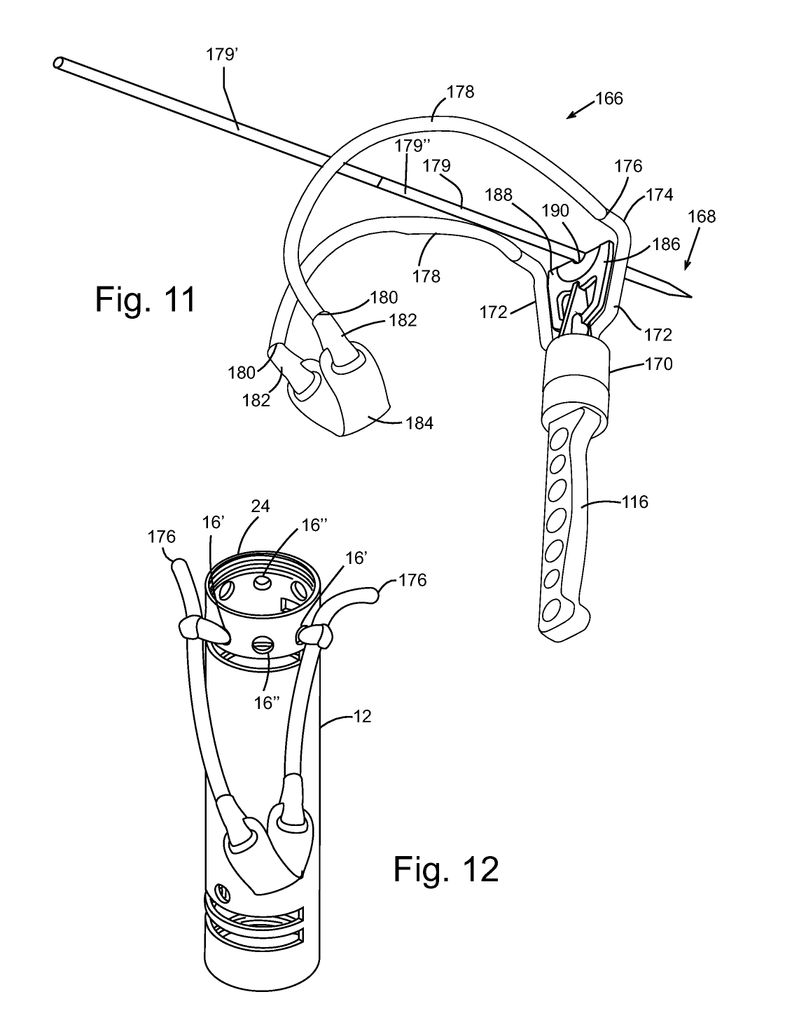

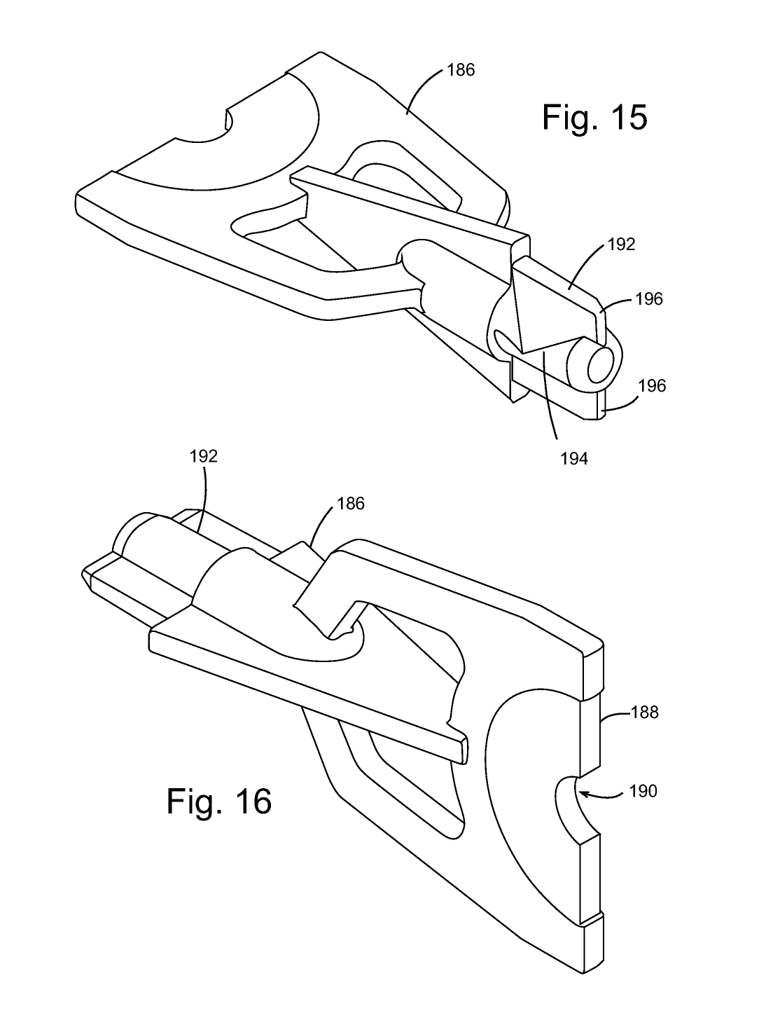

Referring to FIGS. 11, 15, and 16, embodiments of a slingshot and crossbow support are shown. Referring to FIG. 11, in the basic slingshot embodiment the slingshot support 168 is secured to handle part 116 in a fashion similar or identical with the securing of sleeve 118. Thus, the slingshot support 168 is an example of a tool part 110 that replaces sleeve 118 by providing threads 167 (FIG. 1A) as part of support 168. Slingshot support 168 may comprise a pair of laterally spaced upright arms 172 that bend into lateral parts 174, which in use may each connect to a respective end 176 of a respective sling tether 178 of sling tool 166. The bands or tethers 178 may be formed of elastic material such as silicone. The tethers 178 may each have second ends 180 that support a projectile support, for example via connectors 182. Once mounted, the slingshot support 168 and sling 166 combination permit a slingshot to be used to fire projectiles such as rocks.

In a further slingshot embodiment shown, a crossbow or dart support 186 may be added to facilitate the precise launching and aiming of a bolt or dart 179. Referring to FIGS. 11, 15, and 16, the crossbow support 186 may comprise a dart mounting plate 188 defining an indent 190 for receiving and centering a dart or bolt shaft 179. Referring to FIGS. 6A, 11, 15, and 16, the crossbow dart support 186 may be supported and extended from a base stem 192 that mounts within the slingshot support 168. In order to facilitate such a connection, in the example shown a sleeve base 170 of support 168 is provided with the same plate 135, aperture 136, and associated shapes of such parts, as sleeve 118 shown in FIG. 6A. The sleeve base 170 may have an internal bore (not shown) as discussed below.

The base stem 192 may have a cylindrical central part 194 shaped to fit within cylindrical part 133 of aperture 136 of support 186 (visualized by the structure of FIG. 6A used with support 186) and cylindrical part 147 of handle part 116, to centralize the cross bow support 186. Base stem 192 may have one, two, or more lateral wings 196 shaped to fit as a key within rectangular part 139 of aperture 136 (FIG. 6A) and rectangular part 145 of keyway 142 (FIG. 8B). The wing or wings 196 engage the keyway 142 to transfer torque, or more specifically to lock the crossbow support 186 from relative rotation with handle part 116. In the example shown the base stem 192 is free to be axially removed from the support 168, as the above-described components of support 186 act merely to centralize and support the stem 192 rather than secure the stem 192. In other cases the stem 192 may be secured to handle part 116 by the support 186. However, once inserted a dart 179 may be mounted in indent 190, and sling 166 used to fire the dart axially at a target, for example a small rodent, bird, or other animal or desired prey.

Referring to FIG. 12, a further use for sling 166 is illustrated. In the example shown, ends 176 of each tether are tied to respective opposed air vents 16′, such that a pair of aligned air vents 16″ is located between the ends 176 as shown. Such a configuration may be used to load, aim, and launch a dart 179 through aligned air vents 16″. One or more darts 179 may be provided with survival tool 10. In some cases the sling support 186 may be mounted to cap 120. Air vents 16″ may be larger than adjacent vents 16′ for various purposes for example to fit and aim a dart 179. One or more of vents 16 may be adapted to sharpen darts 179, for example by providing a knife edge (not shown). Each dart 179 may be provided in two or more relatively smaller axial segments 179′ and 179″ which may connect, for example thread, together, in order to permit storage of the smaller dart sections within housing 12 or another part of tool 10 when in the storage configuration. each dart 179 may have guidance parts such as fins or feathers (not shown) for straighter flight.

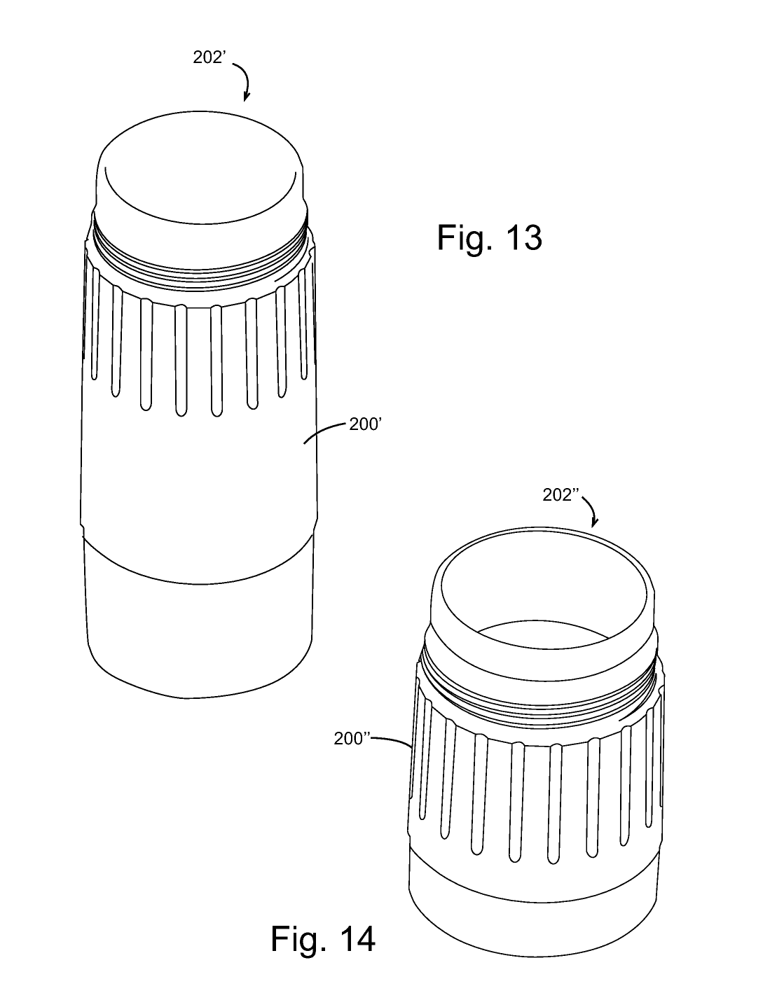

Referring to FIGS. 1A, 1B, and 2, an arrangement of the parts of tool or kit 10 are shown. One example kit package for tool 10 is shown in FIG. 2, with mirror cap assembly 60 mounted to axial end 22 of housing 12, which contains puck 108, cup 50, and all of components 168, 116, 198, 186, 166, 118, 112, and 114 within cup 50. One or more lens 14 may be stored within guide slots 28. Base axial end 24 of housing 12 is threaded to first axial end 104 of screen module 94. Base axial end 106 of screen module 94 may be connected to first axial end 202 of either extension module 200. Base axial end 204 of either extension module 200 connects to first axial end 156 of cap 120. An end nut 214 may be mounted to cap 120, for example by connected box threads 144′ of cap 120 with pin threads 222 of nut 214. Nut 214 may have a lateral aperture 224 projected out of cap 120 for passing tubing 90, which may double as a rope to strap the survival tool kit 10 to a bag, clothing, or other support. Other configurations may be used with survival tool 10. Thus, survival tool 10 provides a compact, multi-function kit that may assist a user in surviving in the wilderness, in addition to providing a convenient mechanism to accompany a user on various long or short term trips outdoors, or as part of an emergency kit. Other supplies may be stored in survival kit 10, for example emergency signaling devices, matches, instructions, inflatable balloons, rafts, food, and others. Also, the tool 10 may be used for water storage. For example, referring to FIG. 13, extension module 200′ may have a closed axial end 202′, which permits storage of distilled or otherwise purified water much like a water bottle, by securing a suitable cap such as cap 120 to axial end 204′. The cup 50 may also store water, for example if a water-tight lid (not shown) is placed on the cup.

Example emergency signaling devices may include flares and SOS balloons. An exemplary SOS balloon may function similar to a hot air balloon in that the heat is supplied by steaming water in the housing 12 and allowing the steam to rise up through the provided silicone tubing to fill a balloon connected to tubing 90 with hot air causing the balloon to rise into the air making for highly visible rescue target.

In some cases the axial position of lens 14 may be adjustable to control the position of the focal point. For example, the lens 14 may be permitted to move axially along housing 12. In some cases lens 14 is mounted at an axial end 22 or 24 of housing 12. Lens 14 may be permanently or removeably installed. The housing 12 may be made of or with fire proof material, such as metal. The housing 12 and some or all of the other parts may be formed by suitable methods such as machining. The word encircling does not require a component with a circular cross-section, as rectangular and polygon or other straight-walled cross-sectional shapes will work. Instead of a removable receptacle or cup 50 an integrally receptacle may be formed in housing 12. The combustion zone may contain the entire or a portion of a combustion process. A cylinder includes a tapered partially conical cylinder, as well as a straight-walled cylinder with parallel non-converging, non-diverging sidewalls. Receptacle could be used for heating or cooking food, such as soup.

In some cases the tool 10 could be shortened by removing the part of the housing 12 above the cup 50, so that in the light concentrating embodiment the lens 14 is mounted in slot 28′″ in the combustion zone, and providing the ability to reverse the axial orientation of the cup, so that in the combustion configuration the top rim 52 faces end 22 away from the combustion zone and the base 54 is adjacent the combustion zone, and in the light concentrating configuration the top rim 52 faces the end 24 and lens 14, and the housing 12 is turned upside down so that the cup 50 is upright in both embodiments. Sleeve 118 and/or tool part 110 may interlock with handle part 116 by a suitable mechanism such as a camlock, or a hook and pin combination. The survival tool 10 may be provided with sufficiently low density to float in water when in the storage configuration. The parts of the universal connector may include male and female parts. The sleeve 118 may be considered a sub-connector.

Plural seats may be provided for cup 50, to permit the cup or receptacle to be fitted into different positions, or different orientations. The seat may be provided as one or more pegs or projections within housing 12, and axial grooves (not shown) may be provided along the cup 50 exterior to permit the cup to slide past the pegs if desired to pass the cup base 54 past the pegs, for example to engage a different seat if the cup 50 is being inverted and nested back in the housing upside down relative to a previous configuration. In some cases one or both of ends 22 and 24 may be closed, for example by a base or top wall, respectively. Any reference to cup 50 may refer to the receptacle in general unless context dictates otherwise. Referring to FIGS. 1A and 1B, each module may have a hand grip or textured/ridged surface to facilitate gripping and turning with a user's hands, for example hand gripping surfaces 76, 91, 208, and 161. Each module may have a pin and box end. In some cases the housing 12 has two pin or two box ends to permit more flexibility in connecting extension modules. Use of the words first, second, third, fourth, fifth, and others to describe configurations are relative, and not an indicator of priority. Each tool part may have a threaded end in some cases. In some cases a part is described with a reference numeral in the description, but then shown in the drawings with the same numeral and a suffix of ′, ″, or ′″ added to distinguish between plural parts of the same type.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A survival tool comprising:
a housing with an encircling wall, the housing defining a heat chamber, the heat chamber having a combustion zone, the housing having an air vent communicating from outside the housing to the combustion zone;
a receptacle;
a magnifying lens; and
in which the survival tool has a first operating configuration where the receptacle is within the heat chamber and oriented so that a combustion process within the combustion zone provides heat to the receptacle, and a second operating configuration where the receptacle is within the heat chamber and the magnifying lens is mounted on a magnifying lens mounting part on the housing and oriented to direct and concentrate light rays from outside the housing to within the heat chamber to heat the receptacle.

2. The survival tool of claim 1 in which the housing is formed of a cylinder.

3. The survival tool of claim 1 in which:
the magnifying lens mounting part comprises a guide slot in the encircling wall for guiding the magnifying lens from outside the housing to within the housing; and
the magnifying lens is located on a cartridge that slides within the guide slot in the encircling wall of the housing to mount the magnifying lens.

4. The survival tool of claim 1 further comprising a cup that defines the receptacle, in which the cup rests upon a seat laterally extended from an inner surface of the encircling wall when the survival tool is in one or both of the first operating configuration and the second operating configuration.

5. The survival tool of claim 4 in which the housing has a first axial end and a second axial end, the air vent is adjacent the first axial end, the magnifying lens mounting part is between the air vent and the second end, and the cup is between the air vent and the magnifying lens mounting part.

6. The survival tool of claim 5 in which:
the receptacle is a water receptacle and a steam release outlet is defined between the cup and the magnifying lens mounting part; and
in one or both the first operating configuration and the second operating configuration, a condensation tube is connected between the steam release outlet and a distilled water receptacle outside the heat chamber.

7. The survival tool of claim 1 in which the magnifying lens is a Fresnel lens, and the magnifying lens mounting part is positioned such, when the magnifying lens is mounted, a focal point defined by the magnifying lens is located on a base surface of the receptacle.

8. The survival tool of claim 1 further comprising a mirror connected by hinge to an axial end of the housing at least when the survival tool is in the first operating configuration, in which the mirror is mounted by hinge to a collar, which is connected, when the survival tool is in the first operating configuration, by threading to the axial end of the housing.

9. The survival tool of claim 1 in which the housing is one of a series of hollow modules threaded end to end to one another when the survival tool is in a storage configuration, in which a plurality of the hollow modules has an encircling wall and defines an internal storage chamber.

10. The survival tool of claim 1 in which the survival tool has a third operating configuration where the magnifying lens is mounted on the magnifying lens mounting part on the housing and oriented to direct and concentrate light rays from outside the housing to within the combustion chamber to ignite flammable material positioned within the combustion zone.

11. The survival tool of claim 10 further comprising a screen positioned within the combustion zone and supporting the flammable material, when the survival tool is in the third operating configuration.

12. The survival tool of claim 1 in which the housing forms a sleeve, and the survival tool has a fourth configuration where a long-distance lens is mounted within the housing to form a telescope.

13. The survival tool of claim 1 in which the housing defines an internal storage chamber, and further comprising:
a handle part;
a plurality of interchangeable tool parts each connectable with the handle part; and
in which the handle part and the plurality of interchangeable tool parts are located within the internal storage chamber when the survival tool is in a storage configuration.

14. The survival tool of claim 13 further comprising a cap for an axial end of the housing, in which the survival tool has a fifth operating configuration in which one of the interchangeable tool parts are mounted to the cap while the cap is mounted to the housing.

15. The survival tool of claim 13 in which the plurality of interchangeable tool parts comprise one or more of a knife blade, a saw blade, a slingshot, a cross-bow support, and a spade.

16. The survival tool of claim 13 in which each of the plurality of interchangeable tool parts have a key extended from the interchangeable tool part, and in which the survival tool further comprises:
a sleeve configured to encircle the key and thread to the handle part to secure a respective interchangeable tool part to the handle part;
a first part associated with one of the handle part or the sleeve, the first part forming a radial stop to restrict relative rotation of the key with the first part while the sleeve is being threaded to the handle part; and
a second part associated with the other of the handle part or the sleeve, the second part forming an axial stop for an axial facing surface of the key to restrict relative axial separation of the key from the handle part when the sleeve is in a threaded position relative to the handle part.

17. The survival tool of claim 16 in which the first part comprises a keyway in the handle part, and the second part comprises a member laterally extended at least partially across an internal axial bore of the sleeve, the member defining an aperture shaped to pass the key in at least one radial position of the key relative to the member.

18. The survival tool of claim 16 in which:
the key has a lobed part with an out-of-round cross-sectional shape, the lobed part being connected to the tool part via a stem;
the keyway and aperture have respective cross-sectional shapes that correspond with the out-of-round cross-sectional shape;
the stem and aperture are shaped to permit relative rotation between the stem and the aperture; and
while the sleeve is being threaded to the handle part the stem rotates within the aperture and the lobed part is clear of the aperture.

19. A method comprising:
in a first configuration of a survival tool, heating the contents of a receptacle within a heat chamber defined by a survival tool housing, using a combustion process in a combustion zone of the heat chamber; and
in a second configuration of the survival tool, heating the contents of the receptacle within the heat chamber, using a magnifying lens mounted on the housing and oriented to direct and concentrate light rays from outside the survival tool housing to within the heat chamber.

20. A survival tool comprising:
a housing defining an internal storage chamber;
a handle part with a first mating part;
a plurality of interchangeable tool parts each having a second mating part connectable with the first mating part; and
in which the handle part and the plurality of interchangeable tool parts are located within the internal storage chamber when the survival tool is in a storage configuration.
